(19) United States
(12) Patent Application Publication
(10) Pub. No.: US 2026/0115594 A1
(43) Pub. Date: Apr. 30, 2026

(54) AI-BASED GAME AND RENDERING ENGINE

(71) Applicant: Advanced Micro Devices, Inc, Santa Clara, CA (US)

(72) Inventors: Pedro Antonio Pena, Orlando, FL (US); Karthik Mohan Kumar, Santa Clara, CA (US); Kunal Tyagi, Tokyo (JP); Michael Burrows, Bellevue, WA (US); Rama Sharma Bangalore Harihara, Santa Clara, CA (US)

(73) Assignee: Advanced Micro Devices, Inc, Santa Clara, CA (US)

(21) Appl. No.: 18/933,136

(22) Filed: Oct. 31, 2024

(51) Int. Cl. A63F 13/52

(52) U.S. Cl. CPC A63F 13/52

(57) ABSTRACT

An artificial intelligence (“AI”) rendering engine is provided herein. The AI rendering engine renders frames for an entity such as an application. This engine supplements or substitutes for at least some of the “normal” functions of a game engine. More specifically, the AI rendering engine includes an “analytical” game engine as well as an AI-based component that performs some of the processing that a traditional game engine would perform.

### BACKGROUND

High performance rendering engines are computationally intensive. For example, high frame rate physics and graphical work requires a great number of calculations to be performed in short time spans. Techniques are constantly being developed to provide improved performance for such engines.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram of an AI rendering engine;

FIG. 4A illustrates an AI rendering engine that is an example of the AI rendering engine of FIG. 3;

FIG. 4B illustrates another example AI rendering engine;

FIG. 5 is a diagram of an AI rendering engine according to another example; and

FIG. 6 is a flow diagram of a method for rendering according to an example.

### DETAILED DESCRIPTION

An artificial intelligence (“AI”) rendering engine is provided herein. The AI rendering engine renders frames for an entity such as an application. This engine supplements or substitutes for at least some of the “normal” functions of a game engine. More specifically, the AI rendering engine includes an “analytical” game engine as well as an AI-based component that performs some of the processing that a traditional non-AI-based game engine would perform.

In one example, the AI-based component performs an extrapolation function to generate additional frames from a low frame rate output of the analytical game engine. In such an example, the analytical game engine generates low fidelity frames (e.g., low resolution, low polygon, low detail frames), and the AI-based component analyzes such frames to extrapolate additional content and frames. The AI-based component detects evolution in a sequence of frames generated by the analytical game engine, where the evolution includes aspects of objects within a scene such as motion, change in orientation, change in pose, evolution of a particular in-game action, or other evolution, and generates new frames to continue such evolution. In examples, the AI-based component generates many frames for each frame generated by the analytical game engine, and thus the AI-based component serves to reduce the work needed to be performed by the analytical game engine. The AI-based component also in some instances generates frames having higher fidelity (e.g., higher resolution, greater detail in geometry and/or movement) than the frames output by the analytical game engine.

In another example, a game engine generates and outputs state describing objects within a scene, where such state describes positions, configurations, and other aspects of the game objects. In this example, the game engine does not generate an image, but simply outputs this state. An AI-based kinematics component evolves this state according to a sequence of “frames” of game engine state, to generate an image rendering of the game state. A vision encoder analyzes the image rendering to generate encoded output that characterizes elements of the image rendering and provides this encoded output to a large language model. The large language model also receives state information (e.g., game events) from the analytical game engine. The large language model generates a prompt for input to the AI-based kinematics to add to the sparse analytical game engine output. Also, the large language model generates an embedding for input to the video generator to guide the video generation. The large language model does not provide an input for the video encoder, but rather uses the output of the video encoder and a prompt generated from the game state to generate the embedding used by the video generator. This combination of analytical game engine with AI-based components allows generation of output content (e.g., frames) with a very simplified game engine.

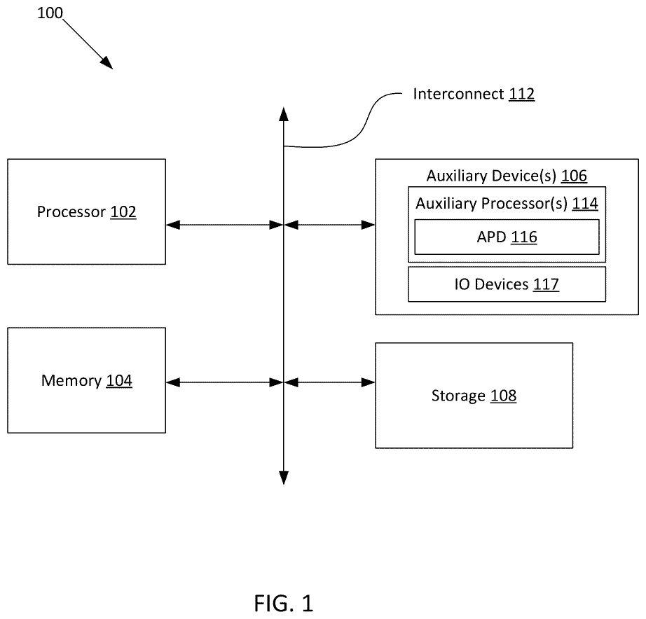

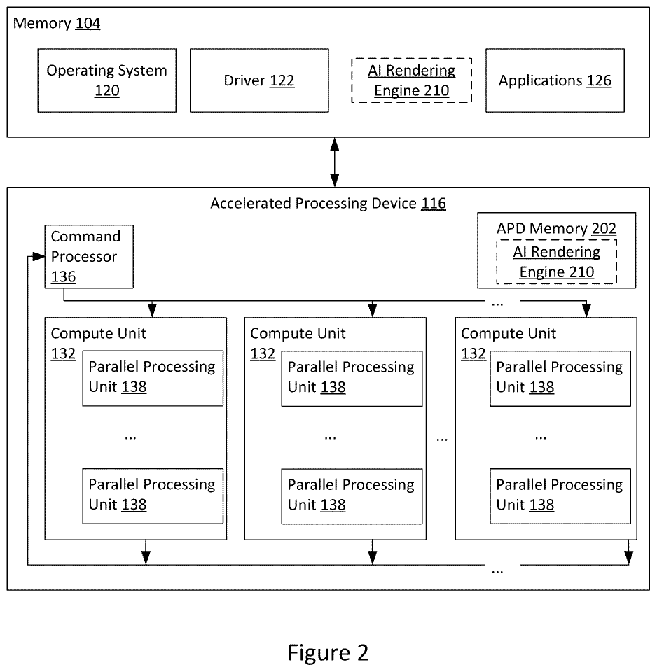

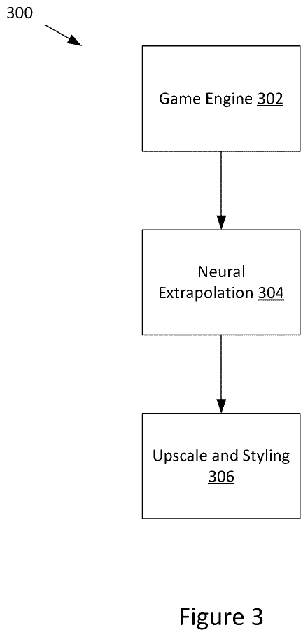

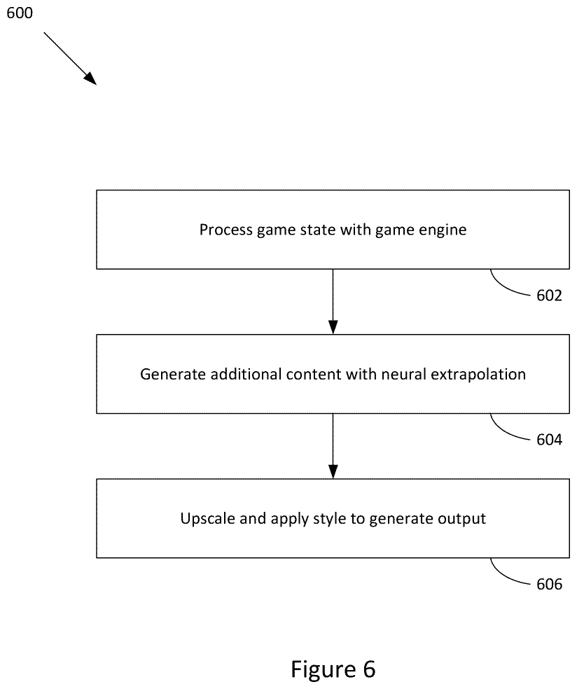

FIGS. 1 and 2 illustrate a system in which an AI-based rendering engine can be employed. FIGS. 3-5 illustrate example implementations of the AI-based rendering engine. FIG. 6 illustrates a method diagram that illustrates a method for performing AI-based rendering.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

An artificial intelligence (“AI”) rendering engine 210 is illustrated in FIG. 2. The AI rendering engine 210 renders frames for an entity such as an application 126. The AI rendering engine 210 supplements and/or substitutes for a traditional rendering and/or video game engine. The AI rendering engine 210 provides features such as physics updates, content extrapolation, detail increase, and/or simplification of application development. The AI rendering engine 210 is implemented as one or more of software or hardware (e.g., digital circuitry) or a combination thereof. In various examples, all or part of the AI rendering engine 210 is within the memory 104, the APD memory 202, the processor 102, the APD 116, or is a combination thereof. In various examples, the AI rendering engine 210 includes software executing on one or both of the processor 102 and the APD 116, as well as hardware (e.g., digital circuitry) within the processor 102, the APD 116, or another location. Additional details follow.

FIG. 3 is a block diagram of an AI rendering engine 300 that is an example of the AI rendering engine 210. The AI rendering engine 300 of FIG. 3 includes a game engine 302, a neural extrapolation component 304, and an upscale and styling component 306. The game engine 302 performs at least some functions of a traditional game engine. Such functions include physics (e.g., tracking the positions of game objects within a scene or world as well as determining how such game objects should be translated or transformed based on a variety of factors such as application of forces, direct modification of position, velocity or acceleration, or modifications to aspects of a 3D model), modification of game state (e.g., object position or other state) based on user inputs, rendering (e.g., generation of an output image representative of game state), and other functions. In various examples, the game engine 302 does not have any AI-based components. Instead, the game engine 302 is an “analytical” engine, meaning that the game engine 302 is directly programmed to perform at least some of its operations (e.g., physics, rendering, and/or modification of game state based on user input) without any neural models. Although it is possible for the game engine 302 to perform some ancillary work via neural models, primarily, work such as game object state updates based on physics and user input is performed directly through specifically programmed algorithms and not via AI-based analysis.

In some examples, the game engine 302 generates a rendered output image based on its tracked updated state, where this output image is human-viewable. In some examples, the output image is at a lower resolution than the resolution desired or set by the entity (e.g., application 126) requesting work be performed by the AI rendering engine 300. More specifically, the application 126 or other entity that utilizes the AI rendering engine 300 sets a particular resolution for output. The game engine 302 generates output images at a lower resolution than this set resolution, and one or more subsequent components of the AI rendering engine 300 (such as the upscale and styling component 306) upscales these output images to generate an upscaled version at the desired resolution. In some examples, instead of or in addition to the rendered frame generated by the game engine 302, the game engine 302 generates semantic information describing the state managed by the game engine 302.

In some examples, the neural extrapolation component 304 performs extrapolation of physical aspects of the output of the game engine 302. In various examples, such “extrapolation” includes determining how the state will progress given the current and past versions of the state, and/or includes supplementing additional elements into the output of the game engine 302. In some examples where the game engine 302 provides a rendered frame, the extrapolation generates new frames based on the rendered frame and, in some examples, based on prior output from the game engine 302 and from the neural extrapolation component 304 and/or the upscale and styling component 306. In other words, in some examples, the neural extrapolation component 304 receives as input, the current frame from the game engine 302 as well as one or more previous frames generated either or both by the game engine 302 and the remainder of the AI rendering engine 300 (e.g., by the neural extrapolation component 304 itself or by the upscale and styling component 306). In some examples where the game engine 302 provides frames of semantic information (where a “frame” includes a set of semantic information for a scene at a particular time point), the neural extrapolation engine 304 provides frames of semantic information for one or more subsequent frames based on the earlier frames from the game engine 302.

In either case, the neural extrapolation component 304 also generates an output image based on the output from the game engine 302. The output image reflects the updates, made by the neural extrapolation component 304, to the game state output by the game engine 302. The upscale and styling component 306 generates an upscaled image that reflects the output from the neural extrapolation component 304 and also has an applied style. A style reflects a modification to a base image that meets the visual features specified by the style. A style applied to the output of the neural extrapolation component 304 helps to generate a consistent output that is in line with the specification provided by an application 126. As described above, the upscaling applied by the upscale and styling component 306 generates a higher resolution image from a lower resolution image output by the neural extrapolation component 304.

In some examples, the neural extrapolation component 304 performs extrapolation based on rules provided by an application 126. In various examples, the rules specify how the state maintained by the game engine 302 changes in response to various events, user inputs, or conditions.

In some examples, the neural extrapolation component 304 provides more detailed features to the output of the game engine 302. In examples, such additional detail includes providing more detailed movement, increasing the detail of models, or modifying the models from frame to frame to provide more lifelike movement than the basic movement generated by the game engine 302.

In some examples, the neural extrapolation component 304 generates its output at a different rate than the rate at which the game engine 302 generates its output. In some examples, this rate difference reduces the amount of work performed by the game engine 302 while still allowing a faster frame generation rate.

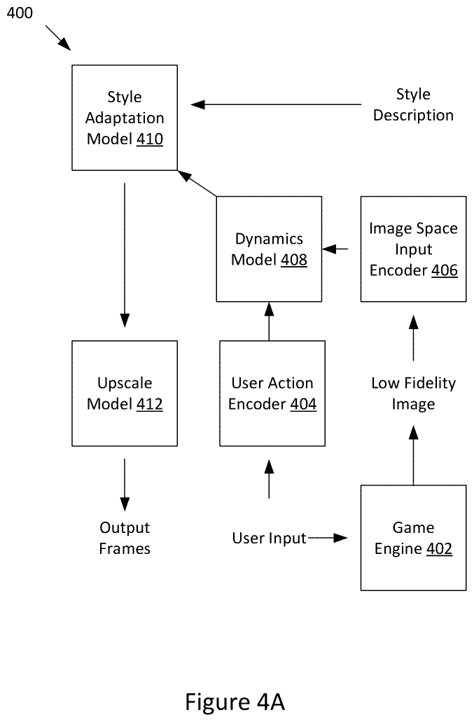

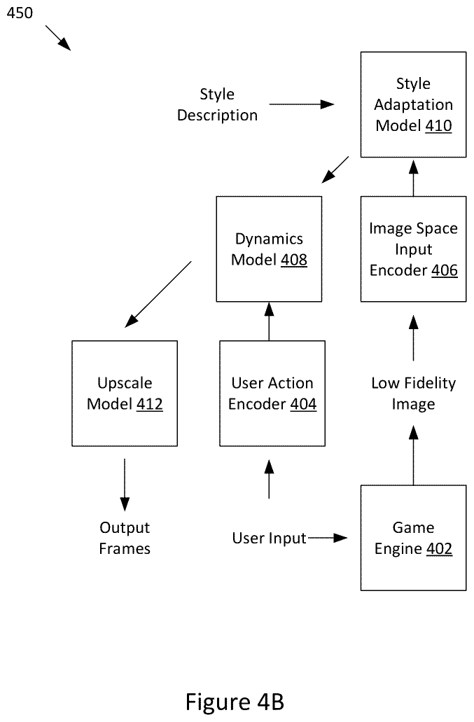

FIG. 4A illustrates an AI rendering engine 400 that is an example of the AI rendering engine 300 of FIG. 3. The AI rendering engine 400 includes a game engine 402, a user action encoder 404, an image space input encoder 406, a dynamics model 408, a style adaptation model 410, and an upscale model 412. Each of these elements can be implemented partially or fully as software executing on a processor (e.g., processor 102 or APD 116), as hardware (e.g., digital circuitry), or as a combination thereof.

In some examples, the game engine 402 is a “low fidelity” game engine that produces an output image based on user input and internal state. The game engine 402 modifies this internal state as programmed and renders output frames, shown as the “low fidelity image” in FIG. 4A. The user input is provided to a user action encoder 404 and the low fidelity image is provided to an image state input encoder 406. Each of these encoders projects the raw data of their inputs to a latent space that extracts the essential features expected by the dynamics model 408. In some examples, the user action encoder 404 and the image space input encoder 406 are AI models that are trained to project data to a latent feature space for the dynamics model 408, given the input illustrated (e.g., user input and low fidelity image). The user action encoder 404 generates encoded user input and the image space input encoder generates an encoded image.

The dynamics model 408 accepts the encoded user input and generates a rendered output frame. In various examples, the dynamics model is trained to “embellish” the “simplified” output provided by the game engine 402. In various examples, the dynamics model 408 extrapolates movements detected in a sequence of frames from the game engine 402 in order to generate additional frames. For example, in situations where the game engine 402 generates frames at a less frequent rate than the dynamics model 408, the dynamics model 408 detects how entities present in the output frames move and extrapolates such movement to generate frames. In some examples, the dynamics model 408 identifies objects, determines a path of movement for those objects, and generates extrapolations that follow a continuation along that path. In some examples, the dynamics model 408 observes other aspects of movement or changes in the scene, such as changes in object position, rotation, scaling, or changes in other effects such as visual effects (e.g., explosions, particle effects). The dynamics model 408 generates subsequent frames to apply extrapolations of such changes to additional new output frames. In some examples, the dynamics model 408 is trained by providing sequences of frames and having the dynamics model 408 generate a subsequent frame, with differences between an actual frame in the sequence and the generated frame being used as a cost function to adjust the weights of the dynamics model 408. In some examples, the output from the dynamics model is at a lower resolution

The style adaptation model 410 applies a style description to the output from the dynamics model 408. In various examples, the style description is in a binary format that describes one or more style parameters. In other examples, the style description is in plain text format or in another format. The style adaptation model 410 is trained to adjust the output of the dynamics model 408 based on that style description. The style adaptation model intakes an image and modifies the pixels such that the modified image retains the initial structure of the image with a modified aesthetic. The modified image retains the initial core structure of the image, but finer details are adapted to conform to the style. All aspects of the image can be stylized, but the core structure should persist. The architecture is a diffusion-based model which is typically a U-Net (a type of convolutional model developed for image segmentation) or a transformer model operating on latent. This is called an LDM (Latent Diffusion Model). Train an LDM for style adaption utilizes a dataset that contains image-X pairs where X can be any modality that describes the style such as text, images, both, and so on.

The style adaptation model 410 provides its output, which includes frames generated with the applied style, to the upscale model 412. The upscale model generates an output frame that is higher resolution than the input from the style adaptation model 410. An example model for upscaling is the “Stable Diffusion x4” model. Upscale models are trained by downscaling high resolution images to generate low resolution images, having an AI architecture generate a higher resolution image based on the lower resolution image, and using the difference between the generated images and the actual high resolution images as a cost function to update the weights of the model. The output frames are then used as final output of the AI rendering engine 400.

In summary, the AI rendering engine 400 generates additional detail and frames for low fidelity images output by the game engine 402. A dynamics model 408 provides “extrapolation” from the relatively simplified content output by the game engine 402. An upscale model 412 generates output frames for subsequent use (e.g., display on a display device).

FIG. 4B illustrates another example AI rendering engine 450. The AI rendering engine 450 of FIG. 4B has similar components to the AI rendering engine 400 of FIG. 4A. However, the arrangement of these components is different than in FIG. 4A. In particular, in the AI rendering engine 450 of FIG. 4B, the style adaptation model 410 acts on the output of the image space input encoder 406 rather than the output of the dynamics model 408. In other words, in the AI rendering engine 450 of FIG. 4B, the style is applied before the dynamics model 408 performs its operations, while in the AI rendering engine 400 of FIG. 4A, the style adaptation model 410 acts on the output of the dynamics model 408. The technique of FIG. 4B provides temporal consistency. This consistency is due to the dynamics model extrapolating the stylized image which considers the mechanics of the stylized components. FIG. 4A has reduced complexity as compared with FIG. 4B.

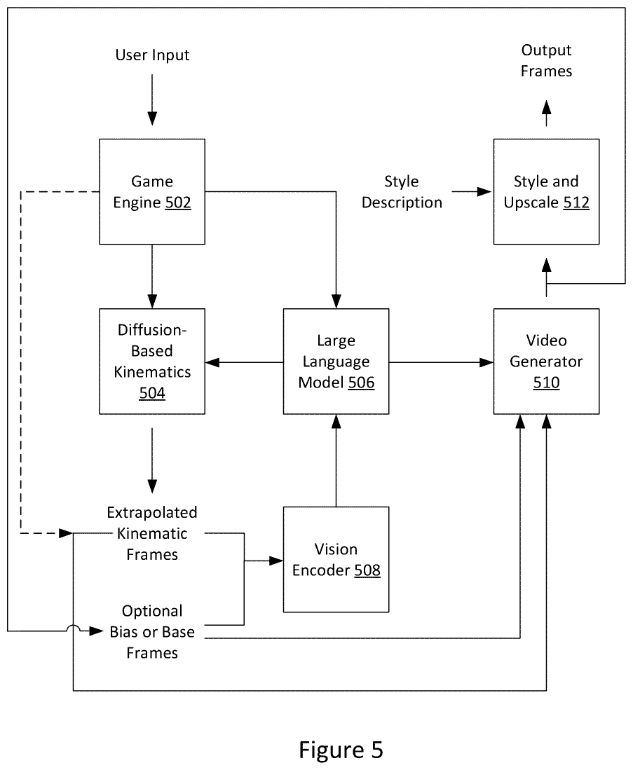

FIG. 5 is a diagram of an AI rendering engine 500 according to another example. The AI rendering engine 500 of FIG. 5 includes a game engine 502, a diffusion-based kinematics component 504, a vision encoder 508, a large language model 506, a video generator 510, and a style and upscale component 512. In this example, the game engine 502 correspond to the game engine 302. The neural extrapolation component 304 corresponds to the following components of FIG. 5: the diffusion-based kinematics component 504, the vision encoder 508, the large language model 506, and the video generator 510. The upscale and styling component 306 corresponds to the style and upscaling component 512 of FIG. 5. Each of these elements can be implemented partially or fully as software executing on a processor (e.g., processor 102 or APD 116), as hardware (e.g., digital circuitry), or as a combination thereof.

The game engine 502 accepts user input and maintains internal state, such as state concerning objects in a scene. In some examples, these objects are highly simplified, represented using a small number of polygons. In some examples, at least some of these objects are “stick figures,” meaning that the objects do not include primitive meshes, textures, or the like, but simply include line segments representing portions of a character (e.g., trunk, head, arms, legs). In some examples, this “stick figure” corresponds to an animation skeleton. The remainder of the AI rendering engine 300 extrapolates this simplified content to generate detailed output images.

The game engine 502 maintains and updates the above simplified state information based on internal rules and user input. In various examples, the game engine 502 evolves the state information based on programmed game physics, with alterations to the course of such evolution based on events such as user input, interactions between game objects, and other programmed in-game events. In various examples, the game engine 502 provides information about the current state managed by the game engine 502 to a diffusion-based kinematics component 504. The game engine 502 also provides information about such state, as well as indications of game events (e.g., user input, object interactions such as collisions, timing-based events, game phase-based events, or any other events that may occur in a game engine) to the large language model 506.

The diffusion-based kinematics engine 504 generates a relatively detailed output image based on the output of the game engine 502. In some examples, the diffusion-based kinematics engine 504 is an autoregressive diffusion-based neural network. The kinematics engine 504 receives encoded information from the large language model 506. This encoded information is the result of the large language model's 506 analysis of the events from the game engine 502. Put differently, the large language model 506 is configured to generate 150 output to control the diffusion-based kinematics component 504. The large language model 506 is configured to analyze its input and generate information to control the output of the diffusion-based kinematics component 504. The information output of the large language model 506 includes generated content that elaborates on the state of the scene as output by the game engine 502. In various examples, the large language model 506 examines the state and generates one or more qualitative descriptive elaborations for what is happening in the scene as output. These qualitative descriptive elaborations may be a summary of the content of the scene, may include additional events that are not already contained within the scene, may describe how objects of the scene should appear (e.g., facial expressions, gestures, or the like), may describe overall scene mood, or may include other elaborations about the scene that are derivable by a large language model 506 and that are not necessarily already present in the output of the game engine 502 (which is simplified). In some examples, the output of the large language model 506 is encoded in a format appropriate for the diffusion-based kinematics engine 504, and is not necessarily in a text format.

The diffusion-based kinematics component 504 models the kinematic position, location, and action prompt describing the high level action of the objects within the scene. The high-level actions are those generated by the large language model 506. In other words, the large language model 506 generates for one or more objects of the scene, a description of the action of such objects.

The diffusion-based kinematics component 504 accepts as input a series of “keyframes” for each object of the scene. Each keyframe includes information about each object. Such information includes the location of the object, the configuration of the object (e.g., transform and configuration of the sub-components (e.g., skeleton limbs) of the object), as well as an “action prompt.” The location and configuration are provided by the game engine 502 and the action prompt is information generated by the large language model 506 which describes the action and/or state of the object. Each key frame is associated with a particular time. It is also possible for some key frames to not include any information from the game engine 502. In such situations, the diffusion-based kinematics component 504 acts on inferred state for game objects not provided. This inferred state is based on previously provided information for such game objects as well as updates to the state generated by the diffusion-based kinematics component 504 itself. In some examples, the diffusion-based kinematics component 504 autoregressively infers any or all of the information not provided by the game engine 502 for any particular key frame. In some examples, the diffusion-based kinematics component 504 performs this action for one or more frames subsequent to a keyframe, thereby generating information for a sequence of states for each game object. As output, the diffusion-based kinematics component 504 generates images. These images reflect the analysis performed by the diffusion-based kinematics component 504 to display and evolve the scene calculated by the game engine 502, and also reflects the analysis performed by the large language model 506. It is possible for the game engine 502 to provide no information for any particular keyframe, in which case the diffusion-based kinematics component 504 will operate unconstrained by the game engine 502.

The output of the diffusion-based kinematics component 504 is provided along with an optional “base” or “bias” image (“base image”) to the vision encoder 508. The base image represents an image that provides “fixed” content. In various examples, this base image represents a setting (e.g., a stadium, a game level, or other type of setting) or context for the objects. The combination of this base image and the output image provided by the diffusion-based kinematics component 504 represent an overall scene. In various examples, the base image is provided by an application that is running or interacting with and/or controlling the game engine 502. This combination is provided to a vision encoder 508. The vision encoder 508 is an AI model that encodes the base images as well as the keyframe images into latent embeddings. This embedding is a context of the set of images, providing information such as what objects are in the image, and what actions and/or state those objects are performing or are in. In some examples, the output of the vision encoder 508 is provided to an adapter model that projects that output into a language embedding space.

The large language model 506 accepts the output of the vision encoder, and, using the “events” provided by the game engine 502, generates an output (e.g., a query) for the video generator 510. The large language model 506 is able to “reason” about the state of the game, given the inputs from the vision encoder 508 and the game engine 502. In various examples, the large language model 506 embellishes the content it receives, providing additional content, events, actions, movement, or other descriptions, as output. In various examples, the large language model 506 generates any of a variety of embellishments, such as game actions that describe how a particular game object behaves at a certain time as well as latent embeddings that guide and/or condition the video generator model. The large language model 506 provides an output as a learned query embedding. The video generator 510 accepts this input as well as the output image generated by the diffusion-based kinematics component 504 and generates a series of frames (video) as output. In some examples, the output of the large language model is processed by an adapter model to be of the appropriate format for the video generator 510. The video generator 510 is configured to generate a sequence of frames, starting with the base image, and evolving as indicated by the input from the large language model 506. In some examples, a control guidance module such as a controlnet or a skip-connection tuner (SC-Tuner) processes the output from the diffusion-based kinematics component 504. A control guidance module guides the diffusion process to a particular image distribution. This is usually done by interacting with attention embedding layers in the diffusion model. In other words, the large language model “reasons about” the content generated by other components (e.g., game engine 502, diffusion-based kinematics component 504, vision encoder 508) and instructs the video generator regarding how the video generator should generate a video including frames subsequent to that provided by the diffusion-based kinematics component 504. The style and upscale component 512 performs functions similar to the style adaptation model 410 and upscale model 412, on the output from the vision generator 510.

FIG. 6 is a flow diagram of a method 600 for rendering according to an example. Although described with respect to the system of FIGS. 1-5, those of skill in the art will recognize that any system configured to perform the steps of the method 600 in any technically feasible order falls within the scope of the present disclosure.

At step 602, the AI rendering engine 300 performs processing through a game engine 302. In some examples, the game engine 302 generates an output frame by generating a visual rendering of its state. In other examples, the game engine 302 does not generate an output frame but instead outputs state information about the objects managed by the game engine 302. In some examples, the objects managed by the game engine 302 are simulated in a relatively simple manner, and the objects are also represented in a relatively simple manner, such as with low polygon models or with “stick figures.”

At step 604, a neural extrapolation component 304 extrapolates the information provided by the game engine 302 to generate more detailed information. Example implementations of the neural extrapolation component 304 include the dynamics model 408 of FIG. 4A and the combination of the diffusion-based kinematics component 504, the large language model 506, the vision encoder 508, and the video generator 510 of FIG. 5. In the example of FIG. 4A, the dynamics model 408 performs extrapolation by identifying the evolution (e.g., motion) of objects in the output of the game engine 302 and generating additional frames (e.g., images) that provide a continuation of such evolution. In the example of FIG. 4B, the combination described above uses several models to identify motion or other physical evolution, conceptually characterize such motion and other aspects of the scene (e.g., via the large language model 506), and generate a set of output frames (e.g., via the video generator 510). Various details about these operations are provided above at least with respect to FIGS. 4A, 4B, and 5, and step 604 encompasses any such operation as described.

At step 606, the upscale and styling component 306 (embodied as, e.g., the style adaptation model 410 and upscale model 412 or the style and upscale model 512) applies a style and performs an upscaling for the output of prior elements of the system. Styling confirms the image to a particular style desired. “Style” is a generic term that encompasses a variety of things at a high level. Applying a style involves changing the pixels of an image in a way that changes how a particular structure looks. In an example, a style adaptation model edits how a person looks in an image. For example, features such as a beard, hair style, or other elements may be altered. Style adaptation models can also change entire models or characters as well as settings. One important aspect of styling is that an input is an image rather than another type of input. Upscaling includes generating a higher resolution image from a lower resolution image, and any technically feasible technique (e.g., AI model) can be used to perform such functionality.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the interconnect 112, the auxiliary devices 106, the auxiliary processors 114, the APD 116, the IO devices 117, the scheduler 136, the AI rendering engine 210, the compute units 132, the parallel processing units 138, the game engine 302, the neural extrapolation component 304, the upscale and styling component 306, the game engine 402, the user action encoder 404, the image space input encoder 406, the dynamics model 408, the style adaptation model 410, the upscale model 412, the game engine 502, the diffusion-based kinematics component 504, the large language model 506, the vision encoder 508, the video generator 510, and the style and upscale component 512 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
processing state and user input in a game engine to output a first set of one or more frames; and
processing the one or more frames using extrapolation processing to generate a second set of one or more frames.

2. The method of claim 1, further comprising performing upscaling on the second set of one or more frames to generate a set of one or more output frames.

3. The method of claim 1, further comprising performing styling on the second set of one or more frames to generate set of one or more output frames.

4. The method of claim 1, wherein each frame of the first set of one or more frames comprises an image.

5. The method of claim 1, wherein each frame of the first set of one or more frames comprises state information about objects of a scene.

6. The method of claim 1, wherein the second set of one or more frames are generated at a higher rate than the first set of one or more frames.

7. The method of claim 1, wherein the extrapolation processing includes utilizing a large language model to generate a prompt based on the first set of one or more frames.

8. The method of claim 7, wherein the large language model is configured to accept as input output from a vision generator that is configured to analyze the first set of frames.

9. The method of claim 8, wherein the large language model is configured to provide the prompt to a video generator to generate the second set of one or more frames.

10. A system comprising:
a memory configured to store state; and
a processor configured to perform operations comprising:
processing the state and user input in a game engine to output a first set of one or more frames; and
processing the one or more frames using extrapolation processing to generate a second set of one or more frames.

11. The system of claim 10, wherein the operations further comprise performing upscaling on the second set of one or more frames to generate a set of one or more output frames.

12. The system of claim 10, wherein the operations further comprise performing styling on the second set of one or more frames to generate set of one or more output frames.

13. The system of claim 10, wherein each frame of the first set of one or more frames comprises an image.

14. The system of claim 10, wherein each frame of the first set of one or more frames comprises state information about objects of a scene.

15. The system of claim 10, wherein the second set of one or more frames are generated at a higher rate than the first set of one or more frames.

16. The system of claim 10, wherein the extrapolation processing includes utilizing a large language model to generate a prompt based on the first set of one or more frames.

17. The system of claim 16, wherein the large language model is configured to accept as input output from a vision generator that is configured to analyze the first set of frames.

18. The system of claim 17, wherein the large language model is configured to provide the prompt to a video generator to generate the second set of one or more frames.

19. A non-transitory computer-readable medium storing instructions that, when executed by a processor, cause the processor to perform operations comprising:
processing state and user input in a game engine to output a first set of one or more frames; and
processing the one or more frames using extrapolation processing to generate a second set of one or more frames.

20. The non-transitory computer-readable medium of claim 19, wherein the operations further comprise performing upscaling on the second set of one or more frames to generate a set of one or more output frames.
